(19) United States
(12) Patent Application Publication
(10) Pub. No.: US 2022/0088962 A1
(43) Pub. Date: Mar. 24, 2022

(54) WHEEL BEARING ASSEMBLY

(71) Applicant: ILJIN GLOBAL Co.,Ltd, Seoul (KR)

(72) Inventor: Bo Young JANG, Seoul (KR)

(73) Assignee: ILJIN GLOBAL Co.,Ltd, Seoul (KR)

(21) Appl. No.: 17/542,715

(22) Filed: Dec. 6, 2021

Related U.S. Application Data
(63) Continuation of application No. PCT/KR2020/007301, filed on Jun. 4, 2020.

(30) Foreign Application Priority Data
Jun. 4, 2019 (KR) 10-2019-0066234

(51) Int. Cl. B60B 27/00; B60B 35/12; F16D 3/24; F16D 3/84; F16D 1/10; F16C 19/18

(52) U.S. Cl. CPC B60B 27/0042; B60B 35/12; F16D 3/24; F16D 3/845; F16C 2326/02; F16D 1/10; F16C 19/183; F16D 2001/103; B60B 27/0094

(57) ABSTRACT

A wheel bearing assembly for rotatably mounting and supporting a wheel to a vehicle body may comprise a wheel hub; at least one inner ring;; an outer ring; and one or more rolling elements. An accommodation space in which a constant velocity joint is accommodated may be formed in a vehicle-body-side end portion of the wheel hub, and one or more recesses for accommodating rolling members of the constant velocity joint may be provided in an inner peripheral surface of the accommodation space along a circumferential direction. A boot fastening ring may be mounted on the wheel hub to mount a rubber boot configured to prevent foreign matters from flowing into the accommodation space. The boot fastening ring may comprise a spline portion on an inner peripheral surface thereof, the spline portion may be coupled to a corresponding spline portion formed on an outer peripheral surface of the wheel hub.

### CROSS-REFERENCE TO RELATED APPLICATIONS

This application is a continuation of International Application No. PCT/KR2020/007301 filed on Jun. 4, 2020, which claims priority to Korean Patent Application No. 10-2019-0066234 filed on Jun. 4, 2019, the entire contents of which are herein incorporated by reference.

### TECHNICAL FIELD

The present invention relates to a wheel bearing assembly for rotatably mounting and supporting a wheel of a vehicle to a vehicle body, and more particularly, to a wheel bearing assembly configured such that a constant velocity joint connected to a driving shaft of a vehicle is inserted into a wheel bearing.

### BACKGROUND ART

A wheel bearing for a vehicle is an equipment for rotatably mounting and supporting a wheel of a vehicle to a vehicle body, and may be classified into a wheel bearing mounted to a driving wheel of a vehicle and a wheel bearing mounted to a driven wheel of a vehicle. Among them, a wheel bearing for a driving wheel is configured such that a constant velocity joint connected to a driving shaft is coupled to the wheel bearing, thereby providing a driving force generated in a driving equipment to the wheel by transmitting the driving force to the wheel bearing through the constant velocity joint.

Referring to FIG. 1, a wheel bearing assembly for a driving shaft (third-generation wheel bearing assembly) used in the related art is exemplarily illustrated. As illustrated in FIG. 1, a wheel bearing assembly 10 for a driving shaft is configured such that a rotary element 20 (for example, a wheel hub) to which a wheel is mounted is coupled to a non-rotary element 30 (for example, an outer ring) fixed to a vehicle body through rolling elements 40. The wheel mounted on the rotary element 20 is rotatably supported with respect to the vehicle body to which the non-rotary element 30 is coupled. A constant velocity joint 50 is mounted on one side of the wheel bearing so that a driving force generated in a driving equipment is transmitted to the wheel bearing.

Specifically, the constant velocity joint 50 is configured as follows. Rolling members 70 (for example, ball members) and an inner member for supporting the rolling members 70 are accommodated in an outer member 60. A central shaft 80 connected to a driving equipment is coupled to the inner member. A stem portion 65 is formed on a wheel-side end portion of the outer member 60 to extend in an axial direction. Splines formed on an outer peripheral surface of the stem portion 65 are engaged with splines formed on an inner peripheral surface of the wheel hub 20 to transmit a driving force generated in the driving equipment to the wheel hub 20.

In the meantime, a rubber boot 90 may be provided in a vehicle-body-side portion of the constant velocity joint 50 to prevent external foreign matters from flowing into the constant velocity joint 50 in which the rolling members 70 are arranged. Specifically, the rubber boot 90 may be formed in a bellows shape with both open end portions. The one end portion of the rubber boot 90 is coupled to the outer member 60 of the constant velocity joint 50 and the other end portion of the rubber boot 90 is coupled to the central shaft 80 of the constant velocity joint 50 so that an internal space of the constant velocity joint 50 is sealed from outside.

However, in the wheel bearing assembly 10 having the above-described structure, the rolling members 70 of the constant velocity joint 50 are configured to be located outside the wheel hub 20 in the axial direction. This increases an axial length of the wheel bearing assembly 10. In addition, the wheel bearing assembly 10 having the above-described structure is configured such that the stem portion 65 is formed on the outer member 60 of the constant velocity joint 50 to extend in the axial direction, and the splines formed on the outer peripheral surface of the stem portion 65 are engaged with the splines formed on the inner peripheral surface of the wheel hub 20 to transmit the driving force to the wheel hub 20. In such a configuration, the stem portion 65 of the constant velocity joint 50 needs to be lengthened. Thus, there may be matters that the total weight of the wheel bearing assembly 10 is increased and noise occurs when the driving force is transmitted via the splines.

In order to solve these matters, there has been proposed a wheel bearing assembly (fourth-generation wheel bearing assembly) having a configuration in which a constant velocity joint (for example, rolling members of the constant velocity joint) is inserted into and coupled to a wheel hub of a wheel bearing. In such a fourth-generation wheel bearing assembly, the constant velocity joint is coupled to the wheel bearing in a state in which a portion of the constant velocity joint is located inward of the wheel hub of the wheel bearing. This may shorten the length of the wheel bearing assembly, thus decreasing the size and weight of the wheel bearing assembly.

However, since the fourth-generation wheel bearing assembly is configured such that the rolling members of the constant velocity joint are inserted into the wheel hub, there is a matter that it is difficult to mount the rubber boot for preventing external foreign matters from flowing into the internal space of the constant velocity joint.

For example, in the case of the conventional wheel bearing assembly illustrated in FIG. 1, one end portion (wheel-side end portion) of the rubber boot 90 may be coupled to the outer member 60 of the constant velocity joint 50 to mount the rubber boot 90. However, in the case of the fourth-generation wheel bearing assembly, the rolling members of the constant velocity joint are inserted into the wheel hub, and the wheel hub performs a function of the outer member of the constant velocity joint. As a result, there is a matter in that it is difficult to secure a mounting area for the wheel-side end portion of the rubber boot 90.

### SUMMARY

### Technical Problem

The present invention is made in view of the above matters, and the present invention is for the purpose of providing a wheel bearing assembly configured such that a constant velocity joint is inserted in and mounted to the wheel hub, wherein a rubber boot for preventing foreign matters from flowing into the constant velocity joint can be stably mounted, thus reducing the risk of tearing or damaging the rubber boot during the manufacturing or operation of the wheel bearing assembly.

### Technical Solution

Representative configurations of the present invention to achieve the above purposes will be described below.

According to an embodiment of the present invention, there is provided a wheel bearing assembly for rotatably mounting and supporting a wheel to a vehicle body. The wheel bearing assembly according to an embodiment of the present invention may comprise a wheel hub having a wheel mounting flange; at least one inner ring mounted on the wheel hub; an outer ring having a vehicle-body-side mounting flange; and one or more rolling elements configured to rotatably support the wheel hub and the inner ring with respect to the outer ring. According to an embodiment of the present invention, an accommodation space in which a constant velocity joint is accommodated may be formed in a vehicle-body-side end portion of the wheel hub, and one or more recesses for accommodating rolling members of the constant velocity joint may be provided in an inner peripheral surface of the accommodation space along a circumferential direction. According to an embodiment of the present invention, a boot fastening ring may be mounted on the wheel hub to mount a rubber boot configured to prevent foreign matters from flowing into the accommodation space. According to an embodiment of the present invention, the inner ring may comprise a cylindrical inner peripheral surface, and the cylindrical inner peripheral surface of the inner ring may be mounted on a press-fitting portion formed on the wheel hub in a press-fitting manner. According to an embodiment of the present invention, the boot fastening ring may comprise a spline portion formed to extend in an axial direction on an inner peripheral surface thereof, and the spline portion of the boot fastening ring may be coupled and mounted to a corresponding spline portion of a spline mounting portion formed on an outer peripheral surface of the wheel hub.

According to an embodiment of the present invention, the boot fastening ring may comprise a boot mounting portion, on which the rubber boot is mounted, on an outer peripheral surface thereof, and the boot mounting portion may be located at a position close to the vehicle body rather than a vehicle-body-side end portion of the outer ring.

According to an embodiment of the present invention, the boot mounting portion may be formed in a groove shape that is radially inwardly depressed from the outer peripheral surface of the boot fastening ring.

According to an embodiment of the present invention, there is provided a wheel bearing assembly for rotatably mounting and supporting a wheel to a vehicle body. The wheel bearing assembly according to an embodiment of the present invention may comprise a wheel hub having a wheel mounting flange; at least one inner ring mounted on the wheel hub; an outer ring having a vehicle-body-side mounting flange; and one or more rolling elements configured to rotatably support the wheel hub and the inner ring with respect to the outer ring. According to an embodiment of the present invention, an accommodation space in which a constant velocity joint is accommodated may be formed in a vehicle-body-side end portion of the wheel hub, and one or more recesses for accommodating rolling members of the constant velocity joint may be provided in an inner peripheral surface of the accommodation space along a circumferential direction. According to an embodiment of the present invention, the inner ring may comprise an extended portion formed to protrude more toward the vehicle body than a vehicle-body-side end portion of the outer ring, and a rubber boot configured to prevent foreign matters from flowing into the accommodation space may be mounted on the extended portion. According to an embodiment of the present invention, the inner ring may comprise a cylindrical press-fitting portion formed on a wheel-side inner peripheral surface thereof, and the cylindrical press-fitting portion may be mounted on a press-fitting portion formed on the wheel hub in a press-fitting manner. According to an embodiment of the present invention, the inner ring may comprise a spline portion formed to extent in an axial direction on a vehicle-body-side inner peripheral surface thereof, and the spline portion may be coupled and mounted to a corresponding spline portion of a spline mounting portion formed on the outer peripheral surface of the wheel hub.

According to an embodiment of the present invention, the spline portion formed on the vehicle-body-side inner peripheral surface of the inner ring may be configured to be partially or entirely located in the extended portion of the inner ring.

According to an embodiment of the present invention, the extended portion of the inner ring may comprise a boot mounting portion, on which the rubber boot is mounted, on an outer peripheral surface thereof.

According to an embodiment of the present invention, the boot mounting portion may be formed in a groove shape that is radially inwardly depressed from an outer peripheral surface of the extended portion.

According to an embodiment of the present invention, the cylindrical press-fitting portion provided in the vehicle-body-side inner peripheral surface of the inner ring may be formed at a length of 7 mm or more along the axial direction.

According to an embodiment of the present invention, the inner ring may be configured to be secured to the wheel hub by plastically deforming the vehicle-body-side end portion of the wheel hub.

According to an embodiment of the present invention, the press-fitting portion of the wheel hub may be formed to have a larger outer diameter than the spline mounting portion.

According to an embodiment of the present invention, a heat-treated hardened portion may be formed on an inner peripheral surface of the accommodation space, and the heat-treated hardened portion may be formed so as to cover all of the recesses formed in the accommodation space.

According to an embodiment of the present invention, a heat-treated hardened portion may be formed on a portion or entirety of the outer peripheral surface of the wheel hub.

According to an embodiment of the present invention, the boot mounting portion provided in the boot fastening ring or the boot mounting portion provided in the inner ring may be configured to be partially or entirely located radially outwardly from the heat-treated hardened portion formed on the inner peripheral surface of the accommodation space.

According to an embodiment of the present invention, the wheel bearing assembly may further comprise a constant velocity joint inserted into and coupled to the accommodation space formed in the vehicle-body-side end portion of the wheel hub.

According to an embodiment of the present invention, the constant velocity joint may be coupled to the wheel hub such that the rolling members are accommodated and mounted in the recesses of the accommodation space provided in the vehicle-body-side end portion of the wheel hub.

Further, the wheel bearing assembly according to the present invention may further comprise other additional configurations without departing from the technical sprit of the present invention.

### ADVANTAGEOUS EFFECTS

A wheel bearing assembly according to an embodiment of the present invention may be configured such that an accommodation space in which rolling members of a constant velocity joint are accommodated is formed in a vehicle-body-side end portion of a wheel hub and the rolling members of the constant velocity joint are inserted and mounted in the accommodation space. Therefore, it is possible to shorten the overall length of the wheel bearing assembly, reduce the size and weight of the wheel bearing assembly, and suppress noise or vibration from occurring when a driving force is transmitted.

Further, a wheel bearing assembly according to an embodiment of the present invention may be configured such that recesses in which rolling members of a constant velocity joint are accommodated are formed on an inner peripheral surface of a vehicle-body-side end portion of a wheel hub, and the rolling members of the constant velocity joint may be supported and held in the inner peripheral surface of the wheel hub without a separate additional member. This makes it possible to further reduce the wheel bearing assembly in size and weight.

In addition, a wheel bearing assembly according to an embodiment of the present invention may be configured such that a boot fastening ring is mounted to a vehicle-body-side end portion of a wheel hub, or an inner ring is formed to further extend in an axial direction, so that a boot mounting portion to which a vehicle-body-side end portion of a rubber boot is coupled is provided in a position protruding more toward a vehicle body rather than an outer ring. Therefore, even in a wheel bearing assembly configured such that a constant velocity joint is inserted inward of a wheel hub, it is possible to easily mount the rubber boot to the wheel bearing assembly without a remarkable structural change, thus preventing foreign matters from flowing into the constant velocity joint (that is, an accommodation space in which rolling members of the constant velocity joint are accommodated).

Furthermore, a wheel bearing assembly according to an embodiment of the present invention may be configured such that a boot fastening ring or an inner ring (vehicle-body-side extended portion of the inner ring) to which a rubber boot is coupled is mounted to a wheel hub via an axial spline. This makes it possible to rotate a boot mounting portion integrally with the wheel hub (and the constant velocity joint), thereby effectively preventing unintended relative rotation (creep) from occurring between a member (for example, the boot fastening ring or the inner ring) to which one end portion (wheel-side end portion) of the rubber boot is coupled and a member (for example, a central shaft of the constant velocity joint) to which the other end portion (vehicle-body-side end portion) of the rubber boot is coupled, and suppressing the rubber boot from being torn or damaged.

### BRIEF DESCRIPTION OF THE DRAWINGS

FIG. 1 exemplarily illustrates a wheel bearing assembly for a vehicle in the related art (third-generation wheel bearing assembly).

FIG. 2 exemplarily illustrates a wheel bearing assembly according to an embodiment of the present invention.

FIG. 3 exemplarily illustrates a cross-sectional structure of the wheel bearing assembly according to an embodiment of the present invention.

FIG. 4 exemplarily illustrates a cross-sectional structure of the wheel bearing assembly illustrated in FIG. 3 in which a constant velocity joint is omitted.

FIG. 5 exemplarily illustrates a structure of a boot fastening ring of the wheel bearing assembly illustrated in FIGS. 2 to 4.

FIG. 6 exemplarily illustrates a cross-sectional structure of a wheel bearing assembly according to another embodiment of the present invention.

FIG. 7 exemplarily illustrates a cross-sectional structure of the wheel bearing assembly illustrated in FIG. 6 in which a constant velocity joint is omitted.

FIG. 8 exemplarily illustrates a structure of an inner ring (in which a boot mounting portion is provided) of the wheel bearing assembly illustrated in FIGS. 6 and 7.

### EXPLANATION OF REFERENCE NUMERALS

100: wheel bearing assembly

200: wheel bearing

210: wheel hub

212: wheel mounting flange (hub flange)

214: press-fitting portion (of the wheel hub)

216: spline mounting portion (of the wheel hub)

220: inner ring

222: extended portion (of the inner ring)

224: cylindrical press-fitting portion (of the inner ring)

226: spline portion (of the inner ring)

228: boot mounting portion (of the inner ring)

230: outer ring

232: vehicle-side mounting flange

240: rolling element

250: accommodation space

260: recess

270: boot fastening ring

272: spline portion (of a boot fastening ring)

274: boot mounting portion (of the boot fasten ring)

300: constant velocity joint

310: rolling member

320: inner member

330: intermediate member

340: central axis

### DETAILED DESCRIPTION

Hereinafter, preferable embodiments of the present invention will be described in detail with reference to the accompanying drawings at such an extent that they may be readily practiced by those ordinary skilled in the art.

Detailed descriptions of parts irrelevant to the present invention will be omitted for the purpose of clearly describing the present disclosure. Throughout the specification, the same constituent elements will be described using the same reference numerals. In addition, the shapes and sizes of the respective constituent elements illustrated in the drawings are arbitrarily illustrated for the sake of convenience of description, and hence the present invention is not necessarily limited to the illustrated shapes and sizes. That is, it should be understood that specific shapes, structures, and characteristics described in the specification may be modified from an embodiment to another embodiment without departing from the spirit and scope of the prevent disclosure, and positions or dispositions of individual constituent elements may be modified without departing from the spirit and scope of the prevent disclosure. Therefore, detailed descriptions to be described below should be construed as non-limitative senses, and the scope of the prevent disclosure should be understood to include appended claims and their equivalents.

### Wheel Bearing Assembly According to an Embodiment of Present invention

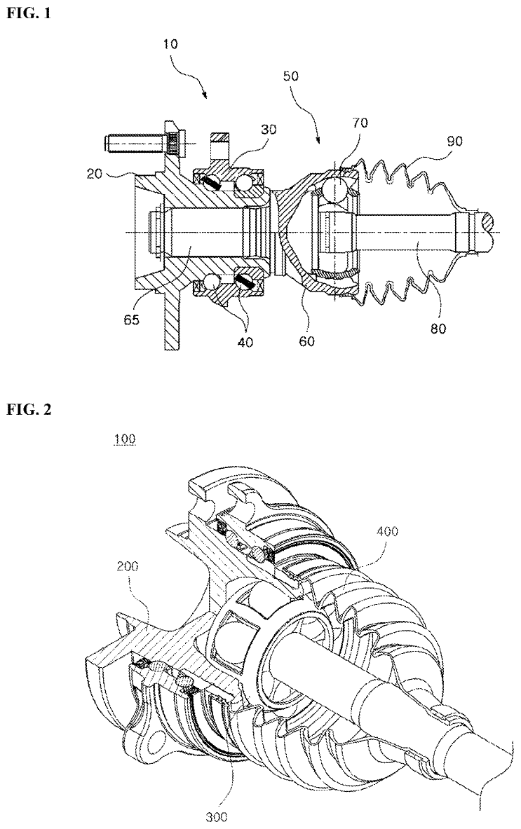

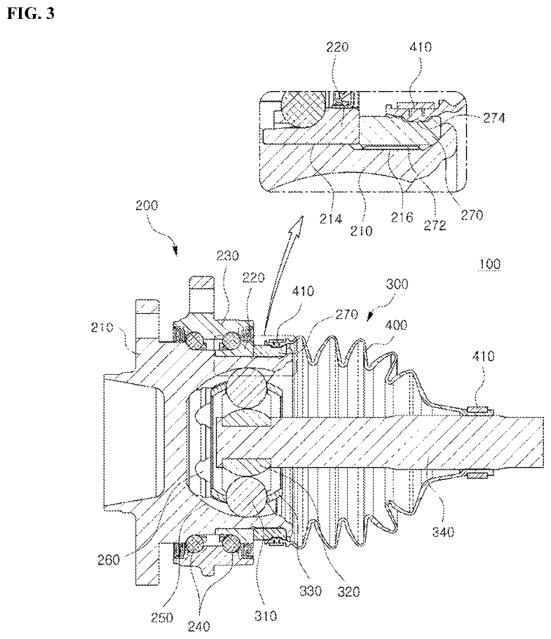

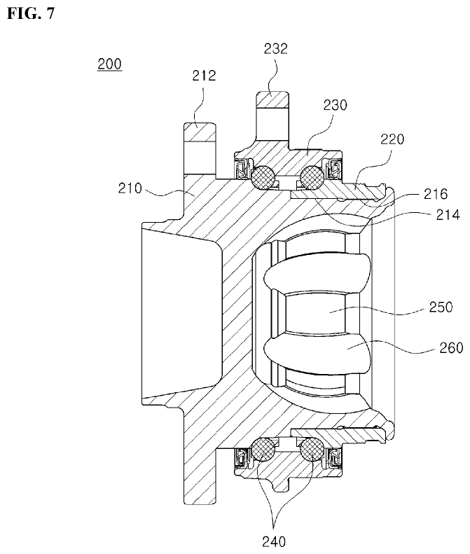

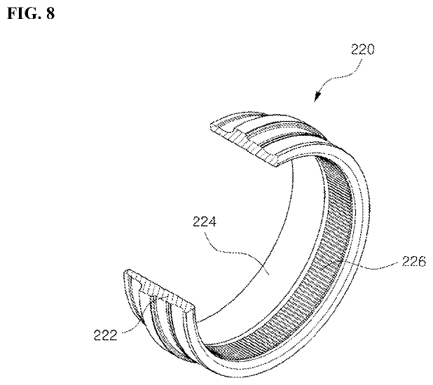

Referring to FIGS. 2 to 8, a wheel bearing assembly 100 according to an embodiment of the present invention is exemplarily illustrated. As illustrated in FIGS. 2 and 3, the wheel bearing assembly 100 according to an embodiment of the present invention may be configured such that an accommodation space in which a constant velocity joint 300 is accommodated is provided in a vehicle-body-side end portion of a wheel hub 210 and the constant velocity joint 300 is inserted into and assembled to a wheel bearing 200.

According to an embodiment of the present invention, the wheel bearing 200 may be formed similar to a conventional wheel bearing for a vehicle. That is, the wheel bearing 200 may be configured such that a rotary element (for example, a wheel hub 210 and an inner ring 220) is mounted on a non-rotary element (for example, an outer ring 230) through rolling elements 240, and the wheel mounted on the rotary element is relatively rotatably supported on the vehicle body to which the non-rotary element is coupled.

According to an embodiment of the present invention, the wheel hub 210 may be formed in a generally cylindrical shape extending along an axial direction. A wheel mounting flange 212 (hub flange) may be provided on an outer peripheral surface of one side of the wheel hub 210. The wheel mounting flange 212 is formed in a shape extending radially outward of the wheel hub 210, and may be used to mount the wheel to the wheel hub 210 via hub bolts or the like. On the other hand, the inner ring 220 may be mounted to a vehicle-body-side end portion (inboard-side end portion) of the wheel hub 210. A raceway (inner raceway) of the rolling elements 240 may be formed on a portion of the outer peripheral surface of the wheel hub 210 to support the rolling elements 240 from the inner side in the radial direction.

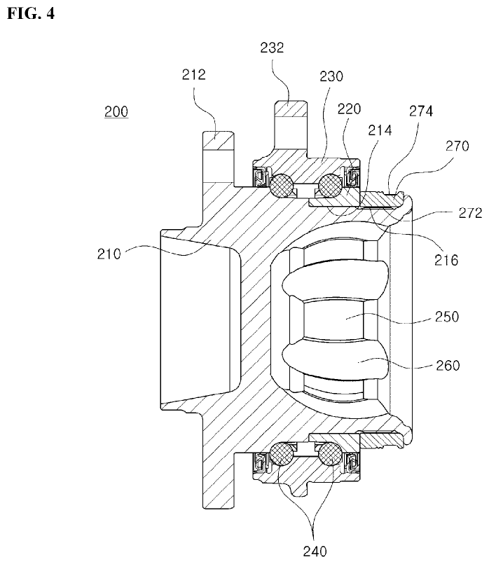

According to an embodiment of the present invention, at least one inner ring 220 may be mounted on the outer peripheral surface of the wheel hub 210, and the inner ring 220 may be configured to have a raceway (inner raceway) for the rolling elements 240 on the outer peripheral surface thereof to support the rolling elements 240 from the inner side in the radial direction. As illustrated in FIGS. 3 and 4, the inner ring 220 mounted on the wheel hub 210 may be configured to be fixed to the wheel hub 210 by plastically deforming the vehicle-body-side end portion of the wheel hub 210 or by coupling a nut or the like to the vehicle-body-side end portion of the wheel hub 210.

According to an embodiment of the present invention, the outer ring 230 may be configured to have a vehicle-body-side mounting flange 232 provided on an outer peripheral surface of the outer ring 230 and used to mount the wheel bearing assembly to the vehicle body, and raceways provided on an inner peripheral surface of the outer ring 230 in contact with the rolling elements 240. The raceway (outer raceway) formed on the inner peripheral surface of the outer ring 230 may be configured to accommodate and support the rolling elements 240, which are rolling bodies, in cooperation between the raceway (the inner raceway) formed on the wheel hub 210 and/or the inner ring 220.

According to an embodiment of the present invention, the rolling elements 240 may be interposed between the rotary element(s) (for example, the wheel hub 210 and/or the inner ring 220) and the non-rotary element (for example, the outer ring 230) to perform a function of rotatably supporting the rotary element(s) to the non-rotary element.

In the embodiments described with reference to the drawings, the wheel bearing is configured such that one inner raceway for supporting the rolling elements is directly formed on a portion of the outer peripheral surface of the wheel hub. However, the wheel bearing according to an embodiment of the present invention is not necessarily limited to such a configuration. The wheel bearing according to an embodiment of the present invention may be modified in various forms. For example, the wheel bearing according to an embodiment of the present invention may be configured such that two inner rings are mounted to the wheel hub and the rolling elements are supported by the two inner rings.

According to an embodiment of the present invention, the vehicle-body-side end portion of the wheel hub 210 may be configured to perform a function of supporting rolling members 310 of the constant velocity joint 300 from the outside (the function performed by the outer member of the constant velocity joint illustrated in FIG. 1). To this end, the wheel bearing 200 according to an embodiment of the present invention may be configured such that an accommodation space 250 is provided in the vehicle-body-side end portion of the wheel hub 210 to accommodate the constant velocity joint 300, recesses 260 are provided in an inner peripheral surface of the accommodation space 250 to accommodate the rolling members 310 of the constant velocity joint 300. Thus, the rolling members 310 of the constant velocity joint 300 may be accommodated and mounted in the recesses 260. According to an embodiment of the present invention, one or more recesses 260 may be formed in the inner peripheral surface of the vehicle-body-side end portion of the wheel hub 210 (the inner peripheral surface of the accommodation space 250) in a spaced-apart relationship with each other along a circumferential direction so as to correspond to the number of rolling members 310 provided in the constant velocity joint 300.

As described above, the wheel bearing assembly 100 according to an embodiment of the present invention is configured such that the rolling members 310 of the constant velocity joint 300 are accommodated in and supported by the inner peripheral surface the inner peripheral surface of the vehicle-body-side end portion of the wheel hub 210 (specifically, the recesses 260 formed on the inner peripheral surface of the vehicle-body-side end portion). Thus, raceways having a high strength needs to be formed on the inner peripheral surface of the vehicle-body-side end portion of the wheel hub 210 in contact with the rolling members 310 of the constant velocity joint 300. Therefore, the wheel bearing assembly 100 according to an embodiment of the present invention is configured to have a heat-treated hardened portion formed on the inner peripheral surface (the inner peripheral surface of the accommodation space 250) of the vehicle-body-side end portion of the wheel hub 210. As a result, the rolling members 310 of the constant velocity joint 300 may be held within the wheel hub 210 in a stable rolling manner.

According to an embodiment of the present invention, the heat-treated hardened portion formed on the inner peripheral surface of the vehicle-body-side end portion of the wheel hub 210 may be configured to have a hardened layer which is formed to include at least all portions in contact with the rolling members 310 of the constant velocity joint 300, so as to ensure the stable rolling motion of the rolling members 310 of the constant velocity joint 300. For example, the heat-treated hardened portion formed on the inner peripheral surface of the vehicle-body-side end portion of the wheel hub 210 may be formed to cover all of the recesses 260 formed in the accommodation space 250 into which the constant velocity joint 300 is inserted.

According to an embodiment of the present invention, a boot mounting portion 274 provided in a boot fastening ring 270 or a boot mounting portion 228 provided in an extended portion 222 of the inner ring 220, which will be described later, may be configured to be partially or entirely located radially outside the heat-treatment hardened portion formed on the inner peripheral surface of the accommodation space 250 to stably mount a rubber boot 400.

Further, the wheel bearing assembly 100 according to an embodiment of the present invention may be configured such that a heat-treated hardened portion is formed on a portion or the entirety of the outer peripheral surface of the wheel hub 210 (e.g., the raceway for the rolling elements, the inner ring mounting portion, and the like). For example, the heat-treated hardened portion formed on the outer peripheral surface of the wheel hub 210 may be formed to extend from a portion close to the wheel rather than the inner raceway for the rolling elements formed on the outer peripheral surface of the wheel hub 210 to the front of the vehicle-body-side end portion of the wheel hub 210 in order to provide a stable raceway and/or a stable mounting surface (press-fitting surface) on the wheel hub 210.

According to an embodiment of the present invention, the heat-treated hardened portion formed on the inner peripheral surface and the outer peripheral surface of the wheel hub 210 may be formed through various well-known heat treatment methods such as high-frequency quenching, full-hardening heat treatment, and the like. Desirably, the heat-treated hardened portion may be thermally treated to have a predetermined hardness (for example, Hv 500 or higher) so as to provide a raceway and/or a mounting surface in a stable form.

According to an embodiment of the present invention, the wheel hub 210 of the wheel bearing 200 may be provided with a boot fastening ring 270 to which a rubber boot 400 for preventing foreign matters from flowing into the constant velocity joint 300 is mounted. As illustrated in FIGS. 2 to 4, the boot fastening ring 270 may be configured to be mounted on the wheel hub 210 at a position close to the vehicle body rather than the inner ring 220. Accordingly, a wheel-side end portion of the rubber boot 400 may be coupled to the wheel hub 210.

According to an embodiment of the present invention, a portion or the entirety of the boot fastening ring 270 may be configured to be located close to the vehicle body rather than the outer ring 230 in the wheel bearing 200. For example, in the case of the embodiment illustrated in the drawings, the vehicle-body-side end portion of the inner ring 220 that supports the vehicle-body-side rolling elements is arranged at substantially the same axial position as the vehicle-body-side end portion of the outer ring 230 and the boot fastening ring 270 is mounted close to the inner ring 220 at the side of the vehicle body so that the boot fastening ring 270 is located close to the vehicle body rather than the outer ring 230. However, the wheel bearing assembly 100 according to an embodiment of the present invention is not limited to such a structure illustrated in the drawings. The wheel bearing assembly 100 according to an embodiment of the present invention may be modified in various forms as long as a portion or the entirety of the boot fastening ring 270 may be located close to the vehicle body rather than the outer ring 230 so that a mounting portion to which the rubber boot 400 is coupled is formed on the outer peripheral surface of the boot fastening ring 270.

According to an embodiment of the present invention, like the wheel bearing in the related art, the inner ring 220 may be configured to be mounted to a press-fitting portion 214 formed on the outer peripheral surface of the wheel hub 210 in a press-fitting manner (for example, to be forcibly press-fitted between the outer peripheral surface and the inner peripheral surface which constitute a cylindrical structure). On the other hand, the boot fastening ring 270 may be configured to be coupled and mounted to a spline mounting portion 216 formed close to the vehicle body rather than the press-fitting portion 214 (for example, in a spline press-fitting coupling manner).

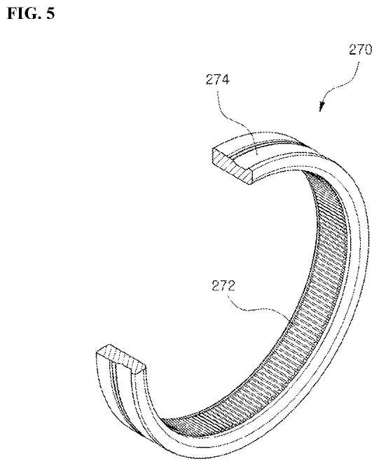

Specifically, the wheel bearing assembly 100 according to an embodiment of the present invention may be configured as follows: the wheel hub 210 comprises the press-fitting portion 214 having a cylindrical shape the spline mounting portion 216 having a spline portion formed to extend along the axial direction on the outer peripheral surface thereof, the inner ring 220 is formed to have a cylindrical inner peripheral surface so as to be mounted on the press-fitting portion 214 of the wheel hub 210 in a press-fitting manner, and the boot fastening ring 270 is formed to have a spline portion 272 on an inner peripheral surface thereof, wherein the spline portion 272 has a corresponding shape so as to be engaged with the spline portion formed in the spline mounting portion 216 of the wheel hub 210 (see FIG. 5). Further, the inner ring 220 may be configured to be forcibly mounted to the press-fitting portion 214 of the wheel hub 210 in a press-fitting manner through the inner peripheral surface of the inner ring 220, and the boot fastening ring 270 may be configured to be coupled and mounted to the spline portion formed in the spline mounting portion 216 of the wheel hub 210 (see FIGS. 3 and 4).

According to an embodiment of the present invention, the press-fitting portion 214 on which the inner ring 220 is mounted may be formed to have an outer diameter larger than that the spline mounting portion 216 on which the boot fastening ring 270 is mounted. By forming the spline mounting portion 216 at a smaller diameter than the press-fitting portion 214 in this way, interference between the inner peripheral surface of the inner ring 220 and the spline mounting portion 216 when mounting the inner ring 220 on the wheel hub 210 can be prevented. This makes it possible to stably mount the inner ring 220 on the wheel hub 210 without damage.

According to an embodiment of the present invention, the boot fastening ring 270 may be configured to comprise a boot mounting portion 274 for coupling one end portion (wheel-side end portion) of the rubber boot 400, which will be described later, on an outer peripheral surface thereof. For example, as illustrated in FIGS. 3 to 5, the boot mounting portion 274 may be formed in a groove shape that is radially inwardly depressed from the outer peripheral surface of the boot fastening ring 270, so that the one end portion (the wheel-side end portion) of the rubber boot 400 is received in and mounted on the boot mounting portion 274.

According to an embodiment of the present invention, the rubber boot 400 may be configured to be mounted between the wheel bearing 200 and the constant velocity joint 300 to prevent external foreign matters from flowing into the constant velocity joint 300 in which the rolling members 310 are arranged.

According to an embodiment of the present invention, as illustrated in FIGS. 2 and 3, the rubber boot 400 may be formed in a bellows shape with both open end portions. The one end portion (the wheel-side end portion) of the rubber boot 400 may be coupled to the boot fastening ring 270 mounted on the wheel hub 210 and the other end portion (vehicle-body-side end portion) of the rubber boot 400 may be coupled to the constant velocity joint 300 (for example, to a central shaft 340 of the constant velocity joint 300 as illustrated in FIG. 3), so that an internal space of the constant velocity joint 300 in which the rolling members 310 are arranged is sealed from the outside. Fastening rings 410 may be mounted in portions at which the both end portions of the rubber boot 400 are coupled, respectively, to ensure the stable mounting of the rubber boot 400.

In the wheel bearing assembly 100 configured as above, the boot mounting portion on which the wheel-side end portion of the rubber boot 400 is coupled is provided close to the vehicle body rather than the outer ring 230. Thus, even in a wheel bearing assembly configured such that rolling members of a constant velocity joint are inserted inward and mounted to the wheel hub, it is possible to easily mount the rubber boot 400 in a stable manner and prevent external foreign matters from flowing into the constant velocity joint.

Further, in the case of the wheel bearing assembly 100 configured such that the rolling members 310 or the like of the constant velocity joint 300 are inserted inward and coupled to the wheel hub 210, when the boot fastening ring 270 is forcedly fastened to the outer peripheral surface of the wheel hub 210 in a press-fitting manner similar to the inner ring 220, there is a risk that an unintended relative rotation (creep) occurs between the wheel hub 210 and the boot fastening ring 270 during the operation of the wheel bearing assembly 100. Such an untended relative rotation may cause a relative rotation between the central shaft 340 of the constant velocity joint 300 that rotates together with the wheel hub 210 and the boot fastening ring 270, which may apply different rotational forces to the both end portions of the rubber boot 400. This may cause damage that the rubber boot 400 is teared, resulting in a degradation in functionality of the rubber boot 400 and a shortened lifespan thereof.

In contrast, the wheel bearing assembly 100 according to an embodiment of the present invention is configured such that the boot fastening ring 270 to which the rubber boot 400 is coupled is mounted on the wheel hub 210 by the axial spline coupling. This prevents the occurrence of an unintended relative rotation (creep) between the boot fastening ring 270 and the wheel hub 210, which allows the boot fastening ring 270 to rotate integrally with the wheel hub 210. This makes it possible to prevent the relative rotation between the central shaft 340 of the constant velocity joint 300 that rotates together with the wheel hub 210 and the boot fastening ring 270, thus suppressing damage to the rubber boot 400 in an efficient manner. In this case, in order to prevent noise from occurring during the operation of the wheel bearing, the spline portion 272 formed on the inner peripheral surface of the boot fastening ring 270 and the corresponding spline portion of the spline mounting portion 216 formed on the outer peripheral surface of the wheel hub 210 may be desirably coupled to each other in a press-fitting manner rather than a loose engagement manner.

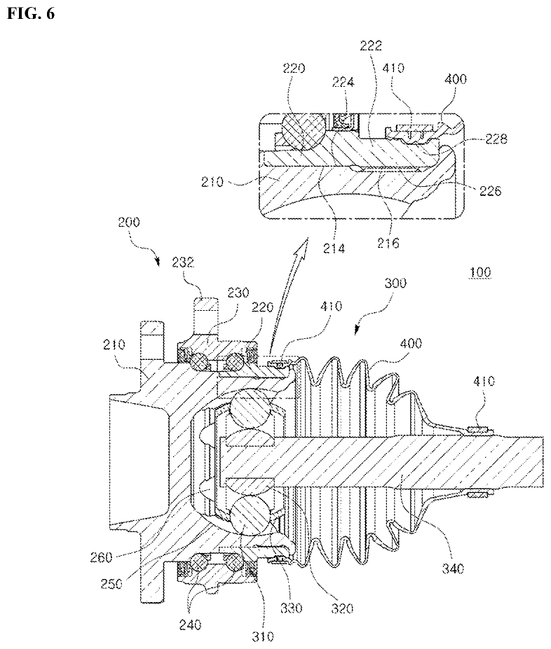

In the meantime, the boot fastening ring to which the rubber boot is coupled may be formed of a member different from that of the inner ring 220 and may be configured to be mounted on the wheel hub 210 at the vehicle-body-side of the inner ring 220, as illustrated in FIGS. 2 to 5. Alternatively, the boot fastening ring may be formed integrally with the inner ring 220, as illustrated in FIGS. 6 to 8.

For example, as illustrated in FIGS. 6 to 8, the wheel bearing assembly 100 according to an embodiment of the present invention may be configured such that the vehicle-body-side end portion of the inner ring 220 extends in the axial direction to further protrude more toward the vehicle body than the outer ring 230, and the extended portion 222 formed at the vehicle-body-side end portion of the inner ring 220 performs the function of the boot fastening ring to which the rubber boot 400 is coupled. That is, the wheel bearing assembly 100 according to an embodiment of the present invention may be configured such that the wheel-side portion of the inner ring 220 performs a function of supporting the vehicle-body-side rolling elements of the wheel bearing, and the vehicle-body-side portion of the inner ring 220 performs a function of mounting the vehicle-body-side end portion of the rubber boot thereon.

According to an embodiment of the present invention, a wheel-side inner peripheral surface of the inner ring 220 may have a cylindrical press-fitting portion 224 formed thereon. The press-fitting portion 224 may be mounted on the press-fitting portion 214 (cylindrical press-fitting portion) formed on the outer peripheral surface of the wheel hub 210 in a press-fitting manner. A vehicle-body-side inner peripheral surface of the inner ring 220 may have a spline portion 226 which is formed to extend in the axial direction and is to be coupled to the corresponding spline portion of the spline mounting portion 216 formed on the outer peripheral surface of the wheel hub 210 (for example, by a press-fitting coupling between the spline portions) (see FIGS. 6 to 8). Further, the extended portion 222 of the inner ring 220, which protrudes more toward the vehicle body than the outer ring 230, may have a boot mounting portion 228 formed on the outer peripheral surface thereof and on which the wheel-side end portion of the rubber boot 400 is coupled. Similar to the boot mounting portion 274 in the embodiments described with reference to FIGS. 2 to 5, the boot mounting portion 228 may be formed in a groove shape that is radially inwardly depressed from the outer peripheral surface of the extended portion 222.

According to an embodiment of the present invention, a portion or the entirety of the spline portion 226 formed on the vehicle-body-side inner peripheral surface of the inner ring 220 may be configured to be located in the extended portion 222 of the inner ring 220. The cylindrical press-fitting portion 224 formed on the wheel-side inner peripheral surface of the inner ring 220 may be formed at least at a length of 7 mm or more in the axial direction so as to be forcibly press-fitted on the press-fitting portion 214 formed on the outer peripheral surface of the wheel hub 210 over a sufficient area.

When a sufficient press-fitting area is not secured between the inner ring 220 and the wheel hub 210, it is difficult to secure concentricity between the inner ring 220 and the wheel hub 210 when the inner ring 220 is mounted on the wheel hub 210. This may cause deformation in the raceway for rolling elements formed on the outer peripheral surface of the inner ring 220 at the time of manufacturing the wheel bearing assembly 100 and during the operation thereof, which may result in occurrence of noise or vibration during the operation of the wheel bearing assembly 100.

In contrast, since the wheel bearing assembly 100 according to an embodiment of the present invention is configured such that the inner ring 220 is mounted on the outer peripheral surface of the wheel hub 210 in a press-fitting manner at least at an axial length of 7 mm or more, the inner ring 220 may be mounted on and held by the wheel hub 210 in a stable manner.

Other configurations may be implemented in substantially the same or similar manner as those of the wheel bearing assembly in the embodiments described above, and therefore more detailed descriptions thereof are omitted.

Further, in the wheel bearing assembly 100 according to an embodiment of the present invention, the constant velocity joint 300, which is connected to a driving shaft of a driving equipment, may be inserted into and coupled to the vehicle-body-side end portion of the wheel hub 210. As illustrated in the drawings, the constant velocity joint 300 according to an embodiment of the present invention may be configured to comprise the rolling members 310, an inner member 320 that supports the rolling members 310 from the inside, an intermediate member 330 (cage) having pockets into which the rolling members 310 are inserted, and the like. The inner member 320 of the constant velocity joint 300 may have a through-hole formed in the central portion thereof. The central shaft 340 connected to the driving shaft of the driving equipment may be inserted into the through-hole.

According to an embodiment of the present invention, the constant velocity joint 300 may be configured such that the rolling members 310, the inner member 320, the intermediate member 330, and the like of the constant velocity joint 300 are accommodated and mounted in the accommodation space 250 formed in the inner peripheral surface of the vehicle-body-side end portion of the wheel hub 210, as illustrated in FIGS. 3 and 6. The rolling members 310 of the constant velocity joint 300 may be configured to be accommodated and mounted in the recess 260 formed in the accommodation space 250.

As described above, the wheel bearing assembly 100 according to an embodiment of the present invention is configured such that the constant velocity joint 300 may be easily inserted inward and coupled to the wheel hub 210 of the wheel bearing 200 without providing any additional member between the wheel bearing 200 and the constant velocity joint 300. This makes it possible to reduce the wheel bearing assembly 100 in size and weight and improve the manufacturing property thereof, compared to those of the wheel bearing assembly in the related art.

While the present invention has been described above by way of particular features such as specific components and the like and exemplary embodiments, these embodiments are provided to further facilitate overall understanding of the present invention, and the present invention is not limited thereto. Various modifications and variations may be made from the above descriptions by those skilled in the art.

Therefore, the spirit of the present invention is not to be limited to the above-described embodiments, and not only the append claims but also all those modified equally or equivalently to the claims are intended to fall within the scope of the spirit of the present invention.

What is claimed is:

1. A wheel bearing assembly for rotatably mounting and supporting a wheel to a vehicle body, comprising:
a wheel hub having a wheel mounting flange;
at least one inner ring mounted on the wheel hub;
an outer ring having a vehicle-body-side mounting flange; and
one or more rolling elements configured to rotatably support the wheel hub and the inner ring with respect to the outer ring,
wherein an accommodation space in which a constant velocity joint is accommodated is formed in a vehicle-body-side end portion of the wheel hub,
one or more recesses for accommodating rolling members of the constant velocity joint are provided in an inner peripheral surface of the accommodation space along a circumferential direction,
a boot fastening ring is mounted on the wheel hub to mount a rubber boot configured to prevent foreign matters from flowing into the accommodation space,
the inner ring comprises a cylindrical inner peripheral surface, and the cylindrical inner peripheral surface of the inner ring is mounted on a press-fitting portion formed on the wheel hub in a press-fitting manner,
the boot fastening ring comprises a spline portion formed to extend in an axial direction on an inner peripheral surface of thereof, and
the spline portion of the boot fastening ring is coupled and mounted to a corresponding spline portion of a spline mounting portion formed on an outer peripheral surface of the wheel hub.

2. The wheel bearing assembly of claim 1, wherein the boot fastening ring comprises a boot mounting portion, on which the rubber boot is mounted, on an outer peripheral surface thereof, and
the boot mounting portion is located at a position close to the vehicle body rather than a vehicle-body-side end portion of the outer ring.

3. The wheel bearing assembly of claim 2, wherein the boot mounting portion is formed in a groove shape that is radially inwardly depressed from the outer peripheral surface of the boot fastening ring.

4. The wheel bearing assembly of claim 1, wherein the inner ring is configured to be secured to the wheel hub by plastically deforming the vehicle-body-side end portion of the wheel hub.

5. The wheel bearing assembly of claim 1, wherein the press-fitting portion of the wheel hub is formed to have a larger outer diameter than the spline mounting portion.

6. The wheel bearing assembly of claim 5, wherein a heat-treated hardened portion is formed on the inner peripheral surface of the accommodation space, and the heat-treated hardened portion is formed so as to cover all of the recesses formed in the accommodation space.

7. The wheel bearing assembly of claim 6, wherein a heat-treated hardened portion is formed on a portion or entirety of the outer peripheral surface of the wheel hub.

8. The wheel bearing assembly of claim 7, wherein a boot mounting portion provided in the boot fastening ring is configured to be partially or entirely located radially outwardly from a heat-treated hardened portion formed on the inner peripheral surface of the accommodation space.

9. The wheel bearing assembly of claim 1, further comprising: a constant velocity joint inserted into and coupled to the accommodation space formed in the vehicle-body-side end portion of the wheel hub,
wherein the constant velocity joint is coupled to the wheel hub such that the rolling members are accommodated and mounted in the recesses of the accommodation space provided in the vehicle-body-side end portion of the wheel hub.

10. A wheel bearing assembly for rotatably mounting and supporting a wheel to a vehicle body, comprising:
a wheel hub having a wheel mounting flange;
at least one inner ring mounted on the wheel hub;
an outer ring having a vehicle-body-side mounting flange; and
one or more rolling elements configured to rotatably support the wheel hub and the inner ring with respect to the outer ring,
wherein an accommodation space in which a constant velocity joint is accommodated is formed in a vehicle-body-side end portion of the wheel hub,
one or more recesses for accommodating rolling members of the constant velocity joint are provided in an inner peripheral surface of the accommodation space along a circumferential direction,
the inner ring comprises an extended portion formed to protrude more toward the vehicle body than a vehicle-body-side end portion of the outer ring, and a rubber boot configured to prevent foreign matters from flowing into the accommodation space is mounted on the extended portion,
the inner ring comprises a cylindrical press-fitting portion formed on a wheel-side inner peripheral surface thereof, and the cylindrical press-fitting portion is mounted on a press-fitting portion formed on the wheel hub in a press-fitting manner; and
the inner ring comprises a spline portion formed to extent in an axial direction on a vehicle-body-side inner peripheral surface thereof, and the spline portion is coupled and mounted to a corresponding spline portion of a spline mounting portion formed on an outer peripheral surface of the wheel hub.

11. The wheel bearing assembly of claim 10, wherein the spline portion provided in the vehicle-body-side inner peripheral surface of the inner ring is configured to be partially or entirely located in the extended portion of the inner ring.

12. The wheel bearing assembly of claim 11, wherein the extended portion of the inner ring comprises a boot mounting portion, on which the rubber boot is mounted, on an outer peripheral surface thereof.

13. The wheel bearing assembly of claim 12, wherein the boot mounting portion is formed in a groove shape that is radially inwardly depressed from an outer peripheral surface of the extended portion.

14. The wheel bearing assembly of claim 13, wherein the cylindrical press-fitting portion provided in the vehicle-body-side inner peripheral surface of the inner ring is formed at a length of 7 mm or more along the axial direction.

15. The wheel bearing assembly of claim 10, wherein the inner ring is configured to be secured to the wheel hub by plastically deforming the vehicle-body-side end portion of the wheel hub.

16. The wheel bearing assembly of claim 10, wherein the press-fitting portion of the wheel hub is formed to have a larger outer diameter than the spline mounting portion.

17. The wheel bearing assembly of claim 16, wherein a heat-treated hardened portion is formed on the inner peripheral surface of the accommodation space, and the heat-treated hardened portion is formed so as to cover all of the recesses formed in the accommodation space.

18. The wheel bearing assembly of claim 17, wherein a heat-treated hardened portion is formed on a portion or entirety of the outer peripheral surface of the wheel hub.

19. The wheel bearing assembly of claim 18, wherein a boot mounting portion provided in the inner ring is configured to be partially or entirely located radially outwardly from a heat-treated hardened portion formed on the inner peripheral surface of the accommodation space.

20. The wheel bearing assembly of claim 10, further comprising: a constant velocity joint inserted into and coupled to the accommodation space formed in the vehicle-body-side end portion of the wheel hub,
wherein the constant velocity joint is coupled to the wheel hub such that the rolling members are accommodated and mounted in the recesses of the accommodation space provided in the vehicle-body-side end portion of the wheel hub.
